(19) United States
(12) Patent Application Publication
(10) Pub. No.: US 2024/0365808 A1
(43) Pub. Date: Nov. 7, 2024

(54) SINGLE SERVE FLOSS MACHINE AND METHODS FOR SAME

(71) Applicant: Gold Medal Products Co., Cincinnati, OH (US)

(72) Inventors: Andrew K. Shang, Centerville, OH (US); Brian K. Brooks, Wilmington, OH (US); Curtis R. King, Morrow, OH (US); Neil D. Velten, West Chester, OH (US)

(21) Appl. No.: 18/652,568

(22) Filed: May 1, 2024

Related U.S. Application Data
(60) Provisional application No. 63/499,652, filed on May 2, 2023.

(51) Int. Cl. A23G 3/10; A23G 3/34

(52) U.S. Cl. CPC A23G 3/10; A23G 3/0051

(57) ABSTRACT

A floss machine includes a base, a head assembly, and a controller. The head assembly is associated with the base and includes a head unit, a heating element, and a motor. The head unit is rotatably coupled with the base and defines a sugar reservoir. The heating element is associated with the head unit and is configured to selectively heat the sugar reservoir. The motor is operably coupled to the head unit to facilitate selective rotation of the head unit relative to the base. The controller is electrically coupled with the heating element and the motor and is configured to operate the head assembly in one of a floss production mode and a standby mode.

### REFERENCE TO RELATED APPLICATION

This application claims priority of U.S. provisional patent application Ser. No. 63/499,652, entitled Single Serve Floss Machine and Methods for Same, filed May 2, 2023, and hereby incorporates this application by reference herein in its entirety.

### TECHNICAL FIELD

The present disclosure relates generally to confectionery production equipment, and more specifically to a single serve floss machine for producing individual servings of cotton candy.

### BACKGROUND

Cotton candy is a popular confection made from heated and spun sugar that forms a light and fluffy edible mass resembling cotton. Traditionally, cotton candy has been produced using a specialized machine with a central sugar reservoir and one or more heated spinning heads. The spinning heads heat and spin the sugar at high speeds, forcing the melted sugar through small openings and causing it to solidify into fine strands that accumulate into the recognizable fibrous cotton candy mass.

There are conventional single-serve cotton candy machines that are designed for making individual cotton candy servings on-demand. However, these types of machines typically heat the head from a cold start which can delay the production of cotton candy. This heating delay substantially reduces the convenience of being able to make fresh cotton candy quickly when desired.

### BRIEF DESCRIPTION OF THE DRAWINGS

Various embodiments will become better understood with regard to the following description, appended claims and accompanying drawings wherein:

FIG. 1 is a front upper isometric view depicting a floss machine that includes a hood;

FIG. 2 is a partially exploded and partially cutaway view of the floss machine of FIG. 1 depicting a head assembly and with the hood removed for clarity of illustration;

FIG. 3 is an exploded view of the head assembly of FIG. 2;

FIG. 4 is a schematic view of a controller in association with various components of the floss machine of FIG. 1;

FIG. 5 is an upper isometric view of a cap of the head assembly of FIG. 3;

FIG. 6 is a lower isometric view of the cap of FIG. 5;

FIG. 7 is a cross section view taken along the line 7-7 of FIG. 5; and

FIG. 8 is a bottom plan view of the cap of FIG. 5.

### DETAILED DESCRIPTION

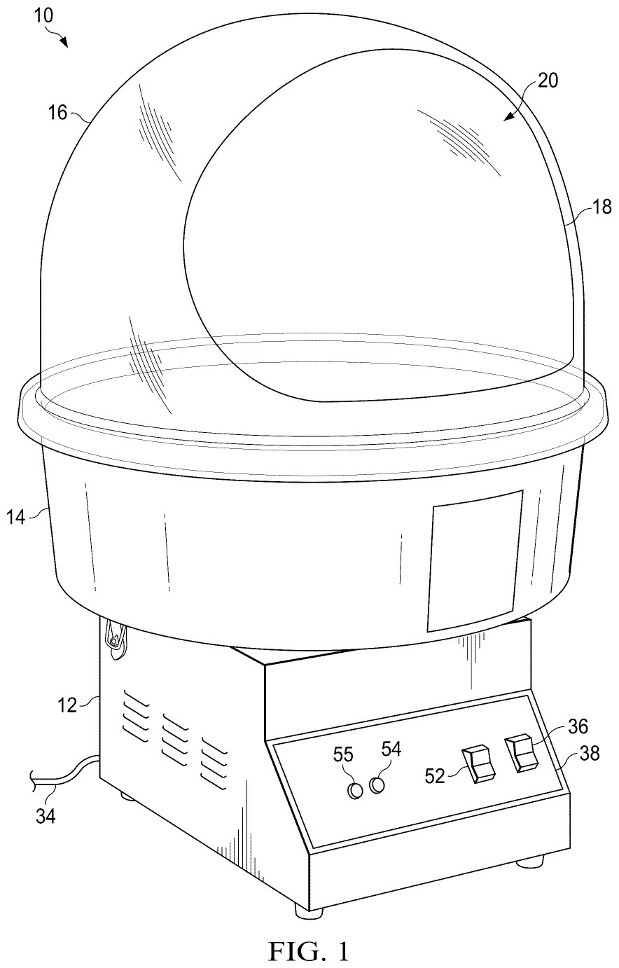

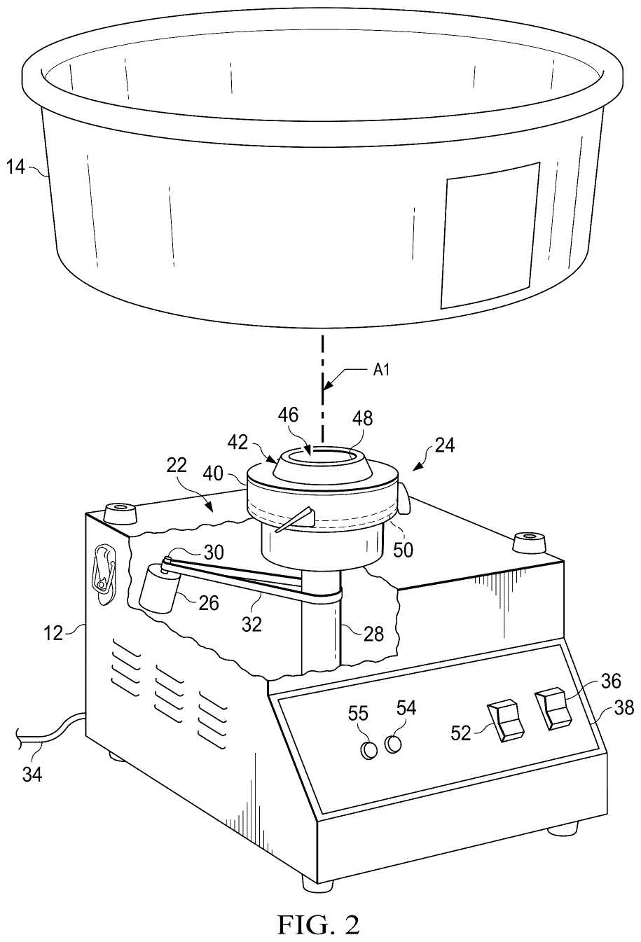

The present disclosure is generally related to a single serve floss machine that is designed to make fresh cotton candy on demand. Single serve floss machines like these are typically implemented in smaller retail settings where large scale floss machines are cost prohibitive but where customers might still want fresh, on-demand, cotton candy. In connection with the views and examples of FIGS. 1-8, wherein like numbers indicate the same or corresponding elements throughout the views, FIGS. 1 and 2 illustrate a single serve floss machine 10 (hereinafter “floss machine 10”) that can include a base 12, a pan 14 that overlies the base 12, and a hood 16 that overlies the pan 14. The hood 16 can define an opening 18 that provides a user access to an interior 20 for gathering spun floss onto a stick or other floss collecting tool.

As illustrated in FIG. 2, the floss machine 10 can include a head assembly 22 that includes a head unit 24 and a motor 26 that is operably coupled with the head unit 24. The head unit 24 can be rotatably coupled with the base 12 and can include a stem 28. The motor 26 can include a driveshaft 30 that rotates when the motor 26 is operated. A belt 32 can be routed around the stem 28 and the driveshaft 30 such that rotation of the driveshaft 30 correspondingly rotates the head unit 24 about a rotational axis A1 via the stem 28. The floss machine 10 can include a cord 34 that can be plugged into an electrical source (e.g., an electrical receptacle) to provide electrical power to the motor 26 and other electrical components onboard the floss machine 10. It is to be appreciated, however, that the floss machine 10 can additionally or alternatively be powered from an onboard power source, such as a battery, which in some examples can be recharged from the cord 34. The floss machine 10 can include a power switch 36 that controls the powering of the floss machine 10 from the cord 34 or other power source. The power switch 36 can be mounted on a faceplate 38 of the floss machine 10 and can be provided in either an “on” position or an “off” position. The power switch 36 is shown to be a rocker switch but can be any of a variety of other suitable switches or switching arrangements that can control the delivery of power to the floss machine 10.

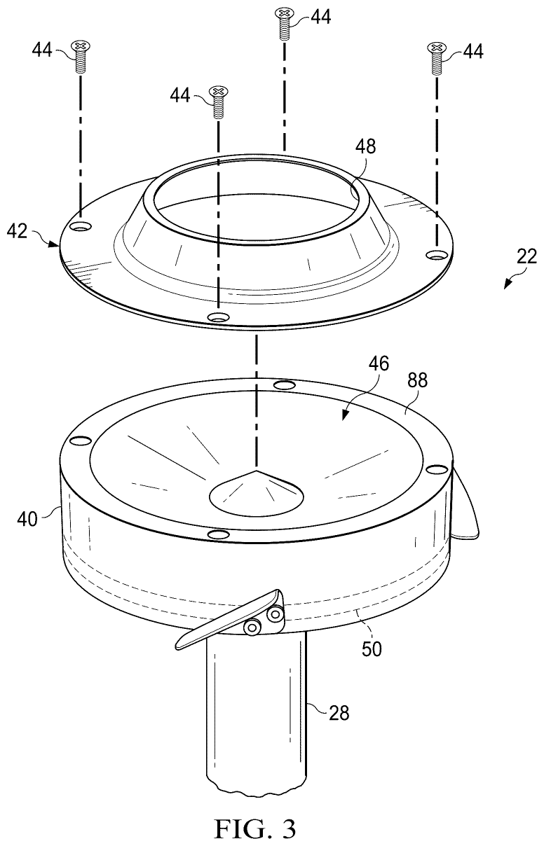

Referring now to FIGS. 2 and 3, the head unit 24 can include a head 40 and a cap 42 that overlies the head 40. The cap 42 can be releasably coupled to the head 40 with threaded fasteners 44 (i.e., screws) or with any of a variety of other suitable releasable fastening arrangements. As illustrated in FIG. 3, the head 40 can define a sugar reservoir 46 that is configured to retain sugar (e.g., floss). The cap 42 can define a central opening 48 that allows the sugar to be introduced into the sugar reservoir 46. The head 40 and cap 42 can be formed of any heat conducting material, such as aluminum, which can be individually cast, machined, stamped, or manufactured with any of a variety of suitable alternative manufacturing methods. A heating element 50 can be embedded into the head 40 adjacent the sugar reservoir 46 and can be selectively energized to facilitate heating of the sugar reservoir 46 to melt the sugar contained therein. In an alternative embodiment, the heating element 50 might be provided adjacent to the head 40 and/or provided at any of a variety of suitable alternative locations on the head 40 that facilitate heating of the sugar reservoir 46. When the sugar is melted, the head unit 24 can be rotated to force the melted sugar between the head 40 and the cap 42 to form the floss strands that can be collected into a cotton candy mass. It is to be appreciated that any of a variety of suitable alternative head assembly and motor combinations are contemplated for producing cotton candy floss as further described herein.

As will be described in further detail below, the head assembly 22 can be operated in either a floss production mode when the floss machine 10 is in use or in a standby mode when the floss machine 10 is not in use. When the head assembly 22 is in the floss production mode, the motor 26 and the heating element 50 are operated at an appropriate speed and temperature, respectively, to produce cotton candy floss from the head unit 24. When the head assembly 22 is in the standby mode, the temperature of the heating element 50 can be reduced to a lower temperature than the floss production mode to keep the heating element 50 warm without letting it cool off completely. The lower temperature of the heating element 50 can prevent charring and burning (e.g., carbonization) of any sugar residue in the head unit 24 that might otherwise occur if the heating element 50 remained at full power while not in use. The lower temperature of the heating element 50 can also allow the head assembly 22 to return to the floss production mode more quickly (e.g., 120 seconds) than if the heating element 50 were completely shut off (e.g., 4 minutes). By providing the head assembly 22 in the standby mode when the floss machine 10 is not in use, the floss machine 10 is better suited for on-demand production of floss (e.g., production of single servings or small batches of floss periodically) than conventional floss machines that must be turned off when not in use.

Referring again to FIGS. 1 and 2, the floss machine 10 can include a mode selection switch 52 that is configured to facilitate manual selection between the floss production mode and the standby mode. The mode selection switch 52 can be mounted on the faceplate 38 and can be a two-position rocker switch that can be manually actuated by a user between a first position and a second position to select between the floss production mode and the standby mode, respectively. It is to be appreciated, however, that the mode selection switch 52 can be any of a variety of other suitable alternative switches for allowing manual control of the operating modes of the head assembly 22. The floss machine 10 can also include two indicators 54, 55 mounted on the faceplate 38 that indicate various different statuses of the floss machine 10 during operation in the floss production mode and the standby mode, as will be discussed in further detail below.

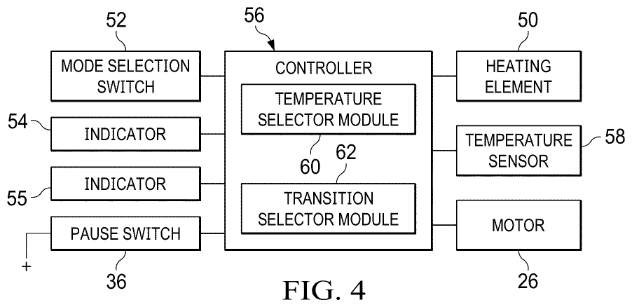

Referring now to FIG. 4, the floss machine 10 can include a controller 56 that is configured to control the operation of the floss machine 10. The controller 56 can be electrically coupled with the power switch 36 such that the controller 56 is selectively powered from the power switch 36. The controller 56 can also be electrically coupled with each of the motor 26 and the heating element 50 such that, during operation, the controller 56 can deliver and control power to the motor 26 and the heating element 50 independently to facilitate selective operation thereof. In one embodiment, the motor 26 and the heating element 50 can be powered with A/C power. In such an embodiment, the controller 56 can include a pair of triacs (not shown) that are each connected to one of the motor 26 and the heating element 50 for controlling the delivery of A/C power to the motor 26 and the heating element 50. It is to be appreciated that the controller 56 can include any suitable additional or alternative types of control circuitry that facilitate delivery and control of the A/C power to the motor 26 and the heating element 50. In an alternative embodiment, the motor 26 and/or the heating element 50 can be powered with DC power. In such an embodiment, the controller 56 can include one or more converters, transformers, or other circuitry that facilitates delivery and control of the DC power to the motor 26 and/or heating element 50.

The controller 56 can be configured to operate the head assembly 22 in either the floss production mode or the standby mode. The controller 56 can be electrically coupled with the mode selection switch 52 to receive indication from a user via the mode selection switch 52 of which mode to operate the head assembly 22 in. For example, a user can switch the mode selection switch 52 between the first position and the second position to operate the head assembly 22 in the floss production mode or the standby mode, respectively. In response, the controller 56 can operate the head assembly 22 in either the floss production mode or the standby mode, respectively.

When the head assembly 22 is provided in the floss production mode, via the mode selection switch 52, the controller 56, in response, can deliver enough operational power to each of the motor 26 and the heating element 50 to rotate and heat the head unit 24 sufficiently enough to produce cotton candy floss. The amount of operational power delivered to the heating element 50 can be preselected and can depend on the operating characteristics of the head unit 24 and the heating element 50. During operation, the controller 56 can regulate the power delivered to the heating element 50 to account for inconsistencies in the line voltage to deliver a consistent amount of power thereto.

Still referring to FIG. 4, a temperature sensor 58 can be electrically coupled with the controller 56. The temperature sensor 58 can be coupled with the head 40, or otherwise associated with the head unit 24, and configured to measure the operating temperature of the head unit 24. In one embodiment, the temperature sensor 58 can comprise a thermostat that changes state (opens or closes) at a particular temperature. In another embodiment, the temperature sensor 58 can be a transducer that provides a real time indication of the temperature of the head unit 24. In some instances, the controller 56 can be configured to regulate the power delivered to the heating element 50 as a function of the detected operating temperature of the head assembly in order to achieve a desired operating temperature as opposed to a predefined power level. In one embodiment, the desired operating temperature can be preset in the controller 56. In another embodiment, the controller 56 can include a temperature selector module 60 that is configured to enable manual selection of the desired operating temperature of the head unit 24. The temperature selector module 60 can comprise a plurality of dip switches, a continuously variable rotary dial, a multi-position rotary dial, or any of a variety of other suitable alternative control arrangements that allow for manual selection of the operating temperature of the head unit 24. The temperature selector module 60 is shown to be mounted onboard the controller 56 such that the temperature selector module 60 is only accessible by gaining access to the interior of the base 12 where the controller 56 is housed. However, it is to be appreciated, that the temperature selector module 60 can alternatively be mounted on the faceplate 38 such that it is readily accessible to a user during operation of the floss machine 10.

In one embodiment, when the floss production mode is first initialized, such as when the floss machine 10 is first powered on or when the mode selection switch 52 is initially moved to the first position, the controller 56 can first provide an amount of boosted power to the heating element 50 that is greater than the operational power described above for producing floss. The boosted power can encourage rapid heating of the head unit 24 by initially heating the head unit 24 to an elevated temperature (e.g., 245 degrees Celsius) that exceeds the operational temperature that is suitable for producing floss (e.g., 230 degrees Celsius) thereby reducing the overall startup time of the head assembly 22. By reducing the boosted power to the operational power, the control of the temperature can be much more manageable and consistent than if the heating element were left at the boosted power. In one embodiment, the boosted power can be about 1300 Watts and the operational power can be about 1100 Watts.

During application of the boosted power, the controller 56 can monitor the temperature of the head unit 24 via the temperature sensor 58. When the temperature reaches the elevated temperature (e.g., a threshold temperature), the controller 56 can switch from powering the heating element 50 with the boost power to powering the heating element 50 with the operational power. This slight reduction in power can cause the temperature of the head unit 24 to return to the operational temperature. As the head unit 24 is being heated to the operational temperature, the indicator 54 can flash with a first color (e.g., green) and can then switch to a solid illumination of the same color when the temperature of the head unit 24 has stabilized to the operational temperature.

In one embodiment, the controller 56 can repeat the transition between the boost power and the operational power multiple times (e.g., 1-3 times) to ensure that the operational temperature is stabilized and is distributed consistently throughout the head 40 and the cap 42. As illustrated in FIG. 4, the controller 56 can include a transition selector module 62 that is configured to enable manual selection of the quantity of transitions between the boost power and the operational power that are to occur before the heating element 50 is finally powered solely by the operational power. The transition selector module 62 can comprise a plurality of dip switches, a multi-position rotary switch, or any of a variety of other suitable alternative control arrangements that allow for selection among different discrete quantities of transitions between the boost power and the operational power. The transition selector module 62 is shown to be mounted onboard the controller 56 such that the transition selector module 62 is only accessible by gaining access to the interior of the base 12 where the controller 56 is housed. However, it is to be appreciated, that the transition selector module 62 can alternatively be mounted on the faceplate 38 such that it is readily accessible to a user during operation of the floss machine 10.

Once the production of floss is complete, the head assembly 22 can then be placed in the standby mode by switching the mode selection switch 52 into the second position. The controller 56, in response, can reduce the power that is delivered to the heating element 50. The reduced power can be less than the operational power but can still provide enough power to keep the heating element 50 at a standby temperature that is cool enough to prevent carbonization of residual sugar in the sugar reservoir 46 yet warm enough to return to the floss production mode quickly. In one embodiment, the reduced power can be about 5% of the operational power.

In one embodiment, when the standby mode is first initialized, the controller 56 can continue to rotate the head unit 24 for a predetermined period of time (e.g., 2 minutes) after the power to the heating element 50 has been reduced. This additional rotation of the head unit 24 can allow for the turbulent air generated through the head unit 24 to expedite cooling thereof. When the head unit 24 is rotating, the indicator 54 can flash a second color (e.g., red) to indicate that the head unit 24 is cooling down. Once the predetermined period of time has elapsed, the controller 56 can terminate operation of the motor 26 to stop rotation of the head unit 24 while still applying the reduced power to the heating element 50. Once the head unit 24 has cooled enough to reach the standby temperature, the indicator 54 can be solidly illuminated with the second color (e.g., red) to indicate that the head assembly 22 is now in the standby mode.

The head assembly 22 can remain in the standby mode while not in use. As described above, when in the standby mode, the temperature of the heating element 50 can be maintained at the standby temperature that is cool enough to prevent carbonization of any residual sugar remaining in the head 40 yet warm enough to significantly reduce the startup time necessary to reach the floss production mode as compared to the heating element 50 being completely deenergized. When the floss machine 10 is ready for use, the user can move the mode selection switch 52 from the second position to the first position to place the head assembly 22 in the floss production mode which thereby activates the motor 26 and heats the heating element 50 in the manner described above to produce floss.

In one embodiment, if the head assembly 22 is not switched to the floss production mode after a predetermined amount of time (e.g., 60 minutes), the controller 56 can be configured to automatically deenergize the heating element 50 to effectively provide the head assembly 22 in a sleep mode. The controller 56 can also cause the indicator 55 to be illuminated with a different solid color (e.g., yellow) to indicate to a user that the heating element 50 is no longer energized and that the head assembly 22 is now in the sleep mode. The operation of the head assembly 22 can be removed from the sleep mode by either cycling the power switch 36 or moving the mode selection switch 52 into the first position. In any event, the head assembly 22 can be returned into the current mode that is selected by the mode selection switch 52.

The floss machine 10 can accordingly be utilized to produce single servings or small batches of cotton candy more effectively than conventional floss machines that are required to be turned off when not in use. The floss machine 10 therefore provides a cost effective, easy to maintain solution that can be implemented in smaller retail settings where larger scale production of cotton candy is oftentimes too difficult, cost prohibitive, or otherwise implausible.

One method of the operation of the floss machine 10 will now be described. First, a user can initialize the operation of the floss machine 10 in the floss production mode by moving the power switch 36 into the “on” position and placing the mode selection switch 52 in the first position to place the head assembly 22 in the floss production mode. In response, the controller 56 can energize the motor 26 to rotate the head unit 24 and can apply the boost power to the heating element 50 to facilitate rapid heating of the head unit 24. Once the temperature of the heating element 50 reaches the desired elevated temperature, the controller 56 can then deliver the operational power to the heating element 50 to reduce the temperature of the head unit 24 to the operational temperature for producing floss that is either preset or manually selected from the temperature selector module 60. In embodiments of the controller 56 that are equipped with a transition selector module 62, the controller 56 can repeat the transition between the boost power and the operational power according to the quantity of transitions that are selected on the transition selector module 62. During the transition between the boost power and the operational power, the indicator 54 can generate a flashing light of a first color (e.g., green) to indicate to a user that the head unit 24 is in the process of reaching the operational temperature.

Once the temperature of the heating element 50 has stabilized to the operating temperature, the indicator 54 can generate a solid light of the first color (e.g., green) to indicate to the user that the floss machine 10 is ready to produce floss. The user can then add sugar to the sugar reservoir 46 to produce the cotton candy floss. When the production of floss is complete, the user can move the mode selection switch 52 into the second position to place the head assembly 22 in the standby mode. In response, the controller 56 can apply the reduced power to the heating element 50 and can rotate the head unit 24 for a predetermined amount of time to enhance cooling of the head unit 24. Once the predetermined amount of time has elapsed, the controller 56 can stop rotating the head unit 24 but can maintain the reduced power to the heating element 50. As the head unit 24 cools, the indicator 54 can generate a flashing light of a second color (e.g., red). Once the head unit 24 reaches the standby temperature, the indicator 54 can generate a solid light of the second color (e.g., red) to indicate that the head assembly 22 is now in the standby mode.

The head assembly 22 can operate in the standby mode for a predetermined amount of time. If, during that predetermined amount of time, the user desires to produce more cotton candy, the user can move the mode selection switch 52 into the first position to place the head assembly 22 in the floss production mode. In response, the controller 56 can operate the motor 26 to rotate the head unit 24 and can apply the boost power and the operational power to the heating element 50 to bring the head unit 24 to the desired operational temperature as described above. During the transition between the boost power and the operational power, the indicator 54 can generate a flashing light of the first color (e.g., green) to indicate that the head unit 24 is in the process of reaching the operational temperature. Once the temperature of the heating element 50 has stabilized to the operating temperature, the indicator 54 can generate a solid light of the first color (e.g., green) to indicate to the user that the floss machine 10 is ready to produce floss.

If, during that predetermined amount of time, the mode selection switch 52 is not activated, the controller 56 can automatically deenergize the heating element 50 to effectively provide the head assembly 22 in a sleep mode. The indicator 55 can generate a solid third color (e.g., yellow) to indicate to the user that the heating element 50 is no longer energized and that the head assembly 22 is now in the sleep mode. If a user desires to produce more cotton candy after the head assembly 22 has entered the sleep mode, the user can either cycle the power switch 36 or move the mode selection switch 52 into the first position which can cause the controller 56 to effectively initialize the operation of the floss machine 10 again.

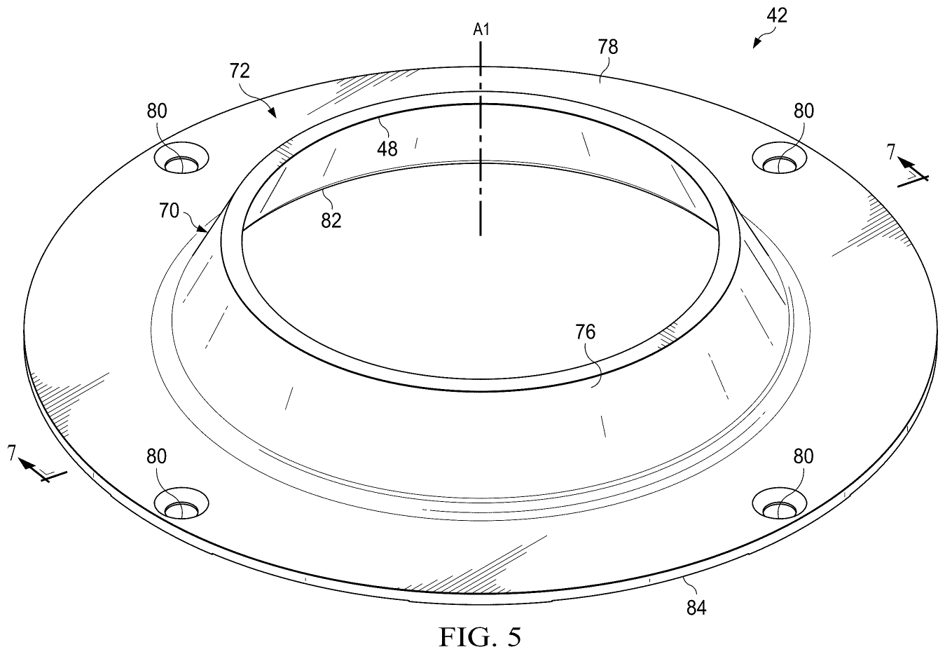

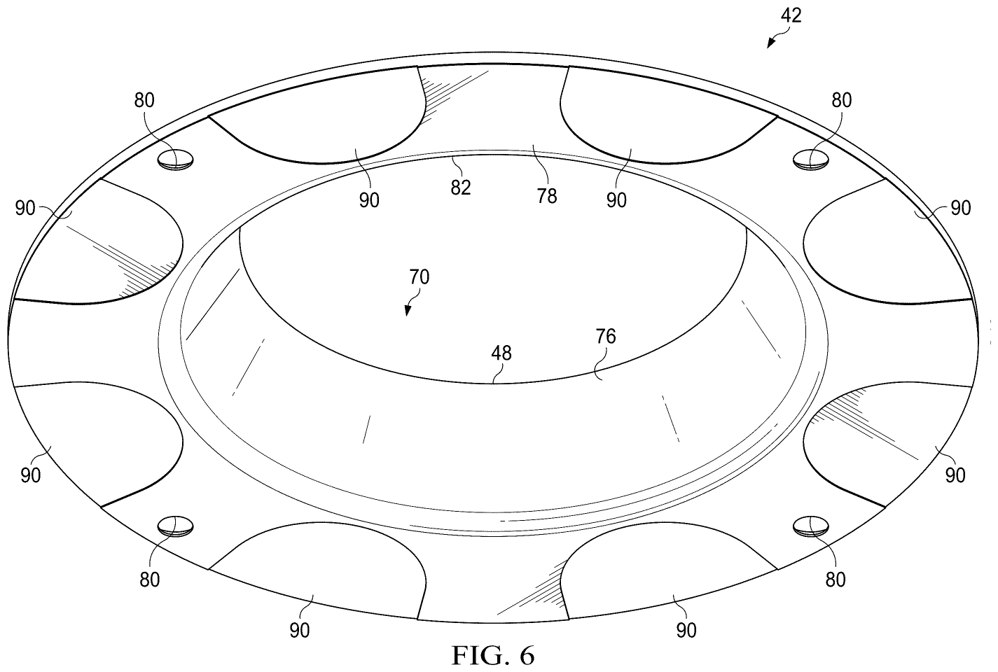

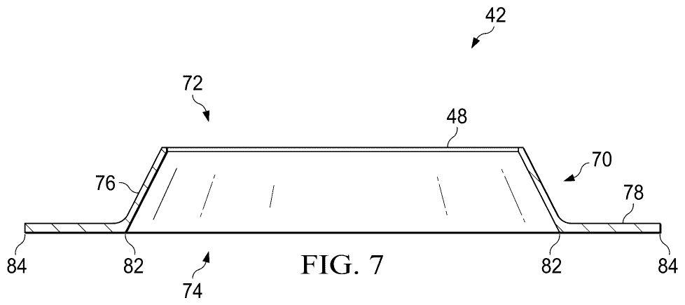

Referring now to FIGS. 5-8, the cap 42 of head unit 24 is shown in further detail in accordance with one embodiment. As illustrated in FIGS. 5 and 6, the cap 42 can include a central portion 70 that extends between an upper end 72 and a lower end 74 of the cap 42 and at least partially defines the rotational axis A1. The central portion 70 can include a sidewall 76 that is routed around a circumference of the cap 42 and that defines the central opening 48 at the upper end 72. The cap 42 can include a flange 78 that is disposed at the lower end 74 of the cap 42 and extends radially outwardly from the sidewall 76. The flange 78 can define a plurality of apertures 80 that accommodate the threaded fasteners 44 that facilitate releasable coupling of the cap 42 to the head 40. As illustrated in FIG. 7, the central portion 70 can be substantially frustoconical shaped such that the sidewall 76 extends upwardly and is angled inwardly as it extends from the lower end 74 to the upper end 72. The central portion 70 can be substantially hollow.

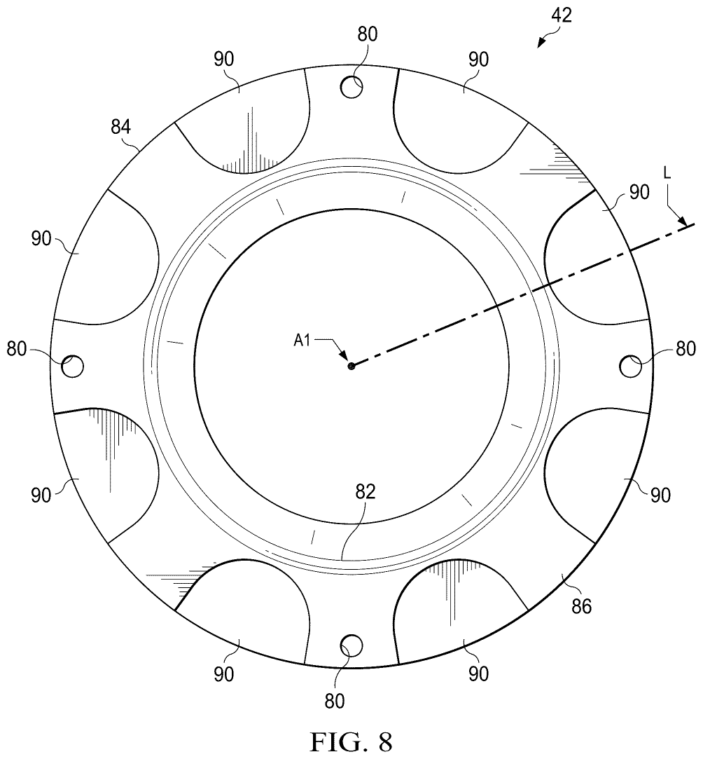

Referring now to FIG. 8, the flange 78 can include an inner perimeter 82 and an outer perimeter 84. The inner perimeter 82 can be located at the interface between the sidewall 76 and the flange 78. The outer perimeter 84 can define the outermost edge of the flange 78. In one embodiment, the flange 78 can be substantially annular shaped such that the inner and outer perimeters 82, 84 are substantially circular. The flange 78 can include a planar surface 86 that extends between the inner and outer perimeters 82, 84 and that interfaces with a corresponding substantially planar surface 88 (see FIG. 3) of the head 40 when secured thereto. The flange 78 can define a plurality of recesses 90 that are effectively indented relative to the planar surface 86. In one embodiment, the recesses 90 can be inset relative to the planar surface 86 by about .006 inches. When the cap 42 is secured to the head 40, the plurality of recesses 90 can provide small openings along the perimeter of the head unit 24 that are sized to allow melted floss strands to escape therethrough. The cap 42 can be formed of a unitary one-piece construction that can be cast, machined, or manufactured via any of a variety of other suitable processes.

The recesses 90 can be evenly distributed along the circumference of the flange 78 such that each recess 90 is spaced apart from adjacent recesses 90 by substantially the same distance. One of the recesses 90 is shown to be intersected by an imaginary radial line L that intersects the rotational axis A1 and extends radially therefrom. That recess 90 will now be described as an illustrative example, but can be understood to be representative of each of the recesses 90. The recess 90 can be spaced radially outwardly from the inner perimeter 82 such that a portion of the planar surface 86 extends between the inner perimeter 82 and the recess 90 along the imaginary radial line L. The recess 90 can extend to the outer perimeter 84. The recess 90 can be symmetrical about the imaginary radial line L (e.g., the portion of the recess 90 that is located on one side of the imaginary radial line L is a mirror image of the portion of the recess 90 located on the other side of the imaginary radial line L). In one embodiment, the recess 90 can be substantially U-shaped.

It is noted that terms like “specifically,” “preferably,” “commonly,” and “typically” are not utilized herein to limit the scope of the claimed invention or to imply that certain features are critical, essential, or even important to the structure or function of the claimed invention. Rather, these terms are merely intended to highlight alternative or additional features that may or may not be utilized in a particular embodiment of the present invention. It is also noted that terms like “substantially” and “about” are utilized herein to represent the inherent degree of uncertainty that may be attributed to any quantitative comparison, value, measurement, or other representation.

The foregoing description of embodiments and examples has been presented for purposes of illustration and description. It is not intended to be exhaustive or limiting to the forms described. Numerous modifications are possible in light of the above teachings. Some of those modifications have been discussed and others will be understood by those skilled in the art. The embodiments were chosen and described for illustration of various embodiments. The scope is, of course, not limited to the examples or embodiments set forth herein, but can be employed in any number of applications and equivalent devices by those of ordinary skill in the art. Rather, it is hereby intended that the scope be defined by the claims appended hereto. Also, for any methods claimed and/or described, regardless of whether the method is described in conjunction with a flow diagram, it should be understood that unless otherwise specified or required by context, any explicit or implicit ordering of steps performed in the execution of a method does not imply that those steps must be performed in the order presented and may be performed in a different order or in parallel.

What is claimed is:

1. A floss machine for preparing cotton candy, the floss machine comprising:
a base;
a head assembly associated with the base and comprising:
a head unit rotatably coupled with the base and defining a sugar reservoir,
a heating element associated with the head unit and configured to selectively heat the sugar reservoir; and
a motor operably coupled to the head unit to facilitate selective rotation of the head unit relative to the base; and
a controller electrically coupled with the heating element and the motor and configured to operate the head assembly in a current mode that is selected from a plurality of modes, wherein the plurality of modes includes a floss production mode in which the controller is configured to:
operate the motor to rotate the head unit; and
power the heating element at a first power to facilitate generation of floss from the head unit;
wherein the plurality of modes includes a standby mode in which the controller is configured to:
power the heating element at a second power that is less than the first power to facilitate cooling of the head unit; and
operate the motor temporarily to facilitate cooling of the head unit.

2. The floss machine of claim 1 wherein for the floss production mode, the controller is further configured to, prior to powering the heating element with the first power, power the heating element with a boosted power that is greater than the first power.

3. The floss machine of claim 2 further comprising a temperature sensor configured to detect the operating temperature of the head unit, wherein the temperature sensor is electrically coupled with the controller and the controller powers the heating element as a function of the operating temperature.

4. The floss machine of claim 3 wherein, the controller is configured to switch from powering the heating element with the boost power to powering the heating element with the first power when the detected operating temperature reaches a threshold temperature.

5. The floss machine of claim 3 wherein:
the controller is configured to regulate the first power to achieve a first temperature or first range of temperatures of the detected operating temperature;
the controller is configured to regulate the first power to achieve a second temperature or second range of temperatures of the detected operating temperature; and
the second temperature or second range of temperatures is less than the first temperature or first range of temperatures, respectively.

6. The floss machine of claim 5 wherein the second temperature or second range of temperatures is about 60% of the first temperature or first range of temperatures.

7. The floss machine of claim 5 further comprising a selector switch that is electrically coupled with the controller and is configured to facilitate selection of a magnitude of the first power.

8. The floss machine of claim 1 further comprising a mode selection switch that is configured to facilitate manual selection between the floss production mode and the standby mode.

9. A method for operating a head assembly of a floss machine, the head assembly comprising a head unit, a heating element associated with the head unit, and a motor operably coupled with the head unit, the method comprising:
receiving a first indication, by a controller, to operate the head assembly in an operating mode and in response to the first indication:
operating the motor, by the controller, to rotate the head unit; and
powering the heating element, by the controller, at an operational power to facilitate generation of floss from the head unit during rotation of the head unit; and
after receiving the first indication, receiving a second indication, by the controller, to operate the head assembly in a standby mode and in response to the second indication:
powering the heating element, by the controller, at a reduced power that is less than the operational power;
operating the motor, by the controller, for a predetermined amount of time to facilitate cooling of the head unit; and
ceasing operation of the motor, by the controller, after the predetermined amount of time has elapsed.

10. The method of claim 9 further comprising, in response to the first indication and prior to powering the head unit at the operational power, powering the head unit at a boost power that is greater than the operational power.

11. The method of claim 10 further comprising:
detecting an operating temperature of the head unit; and
switching from powering the heating element with the boost power to powering the heating element with the operational power when the detected operating temperature reaches a threshold temperature.

12. The method of claim 10 further comprising:
detecting an operating temperature of the head unit;
regulating the operational power to achieve a first operating temperature or first range of operating temperatures for the detected operating temperature; and
regulating the reduced power to achieve a second operating temperature or second range of operating temperatures for the detected operating temperature.

13. The method of claim 12 wherein the second operating temperature is about 60% of the first operating temperature.

14. The method of claim 9 further comprising, in response to the second indication and after the heating element has been powered for a predetermined period of time, ceasing powering of the heating element.

15. The method of claim 9 wherein the floss machine further comprises a mode selection switch that is associated with the controller, the method further comprising providing the first indication and the second indication, by the mode selection switch, to the controller.

16. The method of claim 9 wherein the floss machine further comprises an operational switch, the method further comprising selecting a magnitude of the operational power based on the operational switch.

17. A cap for a head unit of a floss machine, the cap comprising:
a central portion that defines a central opening and an axis of rotation for the head unit; and
a flange that extends radially outward from the central portion and includes an inner perimeter and an outer perimeter, the flange defining a plurality of recesses, wherein each recess of the plurality of recesses:
is intersected by an imaginary line that intersects the rotational axis and extends radially therefrom;
is spaced radially outwardly from the inner perimeter along the imaginary line and extends to the outer perimeter; and
is symmetrical about the imaginary radial line.

18. The cap of claim 17 wherein each recess of the plurality of recesses is substantially U-shaped.

19. The cap of claim 17 wherein the central portion is substantially frustoconical shaped.

20. The cap of claim 17 wherein the cap is formed of a unitary one-piece construction.
